(19) United States
(12) Patent Application Publication
(10) Pub. No.: US 2015/0148224 A1
(43) Pub. Date: May 28, 2015

(54) Oxygen Storage Capacity and Thermal Stability of Synergized PGM Catalyst Systems

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CLEAN DIESEL TECHNOLOGIES INC. (CDTI), Ventura, CA (US)

(21) Appl. No.: 14/090,887

(22) Filed: Nov. 26, 2013

(51) Int. Cl. B01J 23/89

(52) U.S. Cl. CPC B01J 23/8986
USPC 502/324

(57) ABSTRACT

Synergized PGM (SPGM) catalyst systems including ZPGM material compositions and formulations are disclosed. Variations of catalyst systems are tested to determine the synergistic effect of adding ZPGM material to PGM catalysts. The synergistic effect is determined under isothermal oscillating condition from which enhanced OSC property indicates enhanced catalytic behavior of disclosed SPGM catalyst systems as compared with commercial PGM catalysts with OSM for TWC applications. Disclosed SPGM catalyst systems is free of rare earth metals and especially Ce and may have an optimal OSC property and optimal thermal stability that increases with the temperature, showing acceptable level of O₂ storage even at low temperatures.

### CROSS-REFERENCE TO RELATED APPLICATIONS

The present disclosure is related to U.S. patent application Ser. No. 14/090,861, entitled “System and Methods for Using Synergized PGM as a Three-Way Catalyst”, and U.S. patent application Ser. No. entitled “Method for Improving Lean performance of PGM Catalyst Systems: Synergized PGM”, as well as U.S. patent application Ser. No. entitled “Systems and Methods for Managing a Synergistic Relationship between PGM and Copper-Manganese in a Three Way Catalyst Systems”, all filed Nov. 26, 2013, the entireties of which are incorporated by reference as if fully set forth herein.

### BACKGROUND

1. Field of the Disclosure

This disclosure relates generally to three-way catalyst (TWC) systems and, more particularly, to the oxygen storage capacity (OSC) property and thermal stability of synergized PGM catalysts.

2. Background Information

Many modern functional materials are made of multi-phase entities in which cooperative behavior between different components is required to obtain optimal performance. Typical situations of cooperative behavior are modern TWC systems utilized in vehicle exhausts to reduce exhaust gas emissions. TWC systems convert the three main pollutants in vehicle exhaust, carbon monoxide (CO), unburnt hydrocarbons (HC) and oxides of nitrogen (NOₓ), to H₂O, CO₂ and nitrogen. Typical TWC systems include a support of alumina upon which both platinum group metals (PGM) material and promoting oxides are deposited. Key to the desired catalytic conversions is the structure-reactivity interplay between the promoting oxide and the PGM metals, in particular regarding the storage/release of oxygen under process conditions.

Three-way catalysts (TWC), including platinum group metals (PGM) as active sites, alumina-based supports with a large specific surface, and metal oxide promoter materials that regulate oxygen storage properties, are placed in the exhaust gas line of internal combustion engines for the control of NOx, CO, and HC emissions.

Oxygen storage material (OSM) included in a catalyst system is needed for storing excess oxygen in an oxidizing atmosphere and releasing it in a reducing atmosphere. Through oxygen storage and release, a safeguard is obtained against fluctuations in exhaust gas composition during engine operation, enabling the system to maintain a stoichiometric atmosphere in which NOx, CO and HC can be converted efficiently.

Recent environmental concerns for a catalyst's high performance have increased the focus on the operation of a TWC at the end of its lifetime. Catalytic materials used in TWC applications have also changed, and the new materials have to be thermally stable under the fluctuating exhaust gas conditions. The attainment of the requirements regarding the techniques to monitor the degree of the catalyst's deterioration/deactivation demands highly active and thermally stable catalysts in which fewer constituents may be provided to reduce manufacturing costs, offer additional economic alternatives, and maintain high performance materials with optimal OSC property, while maintaining upon the thermal stability and facile nature of the redox function of the used chemical components.

For the foregoing reasons, there is a need for a synergized PGM catalyst system which may have optimal OSC property while maintaining upon the thermal stability and facile nature of the redox function of the used chemical components, and which may exhibit optimal synergistic behavior yielding enhanced activity and performance, and up to the theoretical limit in real catalysts.

### SUMMARY

It is an object of the present disclosure to provide a PGM catalyst including palladium (Pd) which may be synergized adding a Cu—Mn stoichiometric spinel structure to optimize OSC property and performance in TWC applications.

According to one embodiment, a catalyst system may include a substrate, a washcoat (WC) layer, an overcoat (OC) layer, and an impregnation layer. The optimized catalyst system may be achieved after application of a Cu—Mn stoichiometric spinel with Niobium-Zirconia support oxide in a plurality of catalyst configurations including variations of washcoat (WC) layer, overcoat (OC) layer, or impregnation (IM) layer using PGM catalyst with an alumina-based support and Cu—Mn stoichiometric spinel with Niobium-Zirconia support oxide. Both, PGM catalyst on an alumina-based support and Cu—Mn stoichiometric spinel with Niobium-Zirconia support oxide, may be prepared using a suitable synthesis method as known in the art.

According to embodiments in the present disclosure, a synergized PGM (SPGM) catalyst system may be configured with a WC layer including Cu—Mn stoichiometric spinel with Niobium-Zirconia support oxide, an OC layer including PGM catalyst with alumina-based support, and suitable ceramic substrate; or a WC layer including PGM catalyst with alumina-based support, an OC layer including Cu—Mn stoichiometric spinel with Niobium-Zirconia support oxide, and suitable ceramic substrate; or a WC layer with alumina-based support only, an OC layer including Cu—Mn stoichiometric spinel with Niobium-Zirconia support oxide, an IM layer including PGM, Pd in present disclosure, and suitable ceramic substrate; or a WC layer only, including Cu—Mn stoichiometric spinel with Niobium-Zirconia support oxide milled with a slurry including Pd and alumina and suitable ceramic substrate. All SPGM catalyst systems in this disclosure may be free of rare earth metals.

The OSC property of disclosed SPGM catalyst systems may be determined using CO and O₂ pulses under isothermal oscillating condition, referred as OSC test, to determine O₂ and CO delay times. Performance of disclosed SPGM catalyst systems and commercial PGM catalyst may be compared under isothermal oscillating condition in which fresh and hydrothermally aged samples of disclosed SPGM catalyst systems and PGM catalyst may be subjected to isothermal OSC test. Samples may be hydrothermally aged employing about 10% steam/air in a range of temperatures from about 700° C. to about 1,000° C. for about 4 hours.

According to principles in the present disclosure, OSC property of SPGM catalyst systems may be provided at a plurality of temperatures within a range of about 100° C. to about 600° C. under oscillating condition to show temperature dependency of OSC property.

It may be found from the present disclosure that although the catalytic activity, and thermal and chemical stability of a catalyst during real use may be affected by factors, such as the chemical composition of the catalyst, the OSC property of disclosed SPGM catalyst systems may provide an indication that for catalyst applications, and, more particularly, for catalyst systems, the chemical composition of disclosed SPGM catalyst systems may be more efficient operationally-wise, and from a catalyst manufacturer's viewpoint, an essential advantage given the economic factors involved.

Numerous other aspects, features and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows a SPGM catalyst system configuration referred as SPGM catalyst system Type 1, according to an embodiment.

FIG. 2 illustrates a SPGM catalyst system configuration referred as SPGM catalyst system Type 2, according to an embodiment.

FIG. 3 depicts a SPGM catalyst system configuration referred as SPGM catalyst system Type 3, according to an embodiment.

FIG. 4 illustrates a SPGM catalyst system configuration referred as SPGM catalyst system Type 4, according to an embodiment.

FIG. 5 shows OSC isothermal oscillating test results for fresh sample of SPGM catalyst system Type 1 at 575° C., according to an embodiment.

FIG. 6 shows OSC isothermal oscillating test results for fresh sample of SPGM catalyst system Type 2 at 575° C., according to an embodiment.

FIG. 7 illustrates OSC property for fresh sample of SPGM catalyst system Type 3 with variation of temperature, according to an embodiment.

FIG. 8 shows comparison of O₂ delay time results from OSC isothermal oscillating tests performed at 575° C., for fresh and hydrothermally aged samples of SPGM catalyst systems Type 1, Type 2, Type 3, Type 4, and commercial PGM catalyst with OSM, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms may have the following definitions:

“Platinum group metal (PGM)” refers to platinum, palladium, ruthenium, iridium, osmium, and rhodium.

“Catalyst” refers to one or more materials that may be of use in the conversion of one or more other materials.

“Substrate” refers to any material of any shape or configuration that yields a sufficient surface area for depositing a washcoat and/or overcoat.

“Washcoat” refers to at least one coating including at least one oxide solid that may be deposited on a substrate.

“Overcoat” refers to at least one coating that may be deposited on at least one washcoat or impregnation layer.

“Synergized platinum group metal (SPGM) catalyst” refers to a PGM catalyst system which is synergized by a non-PGM group metal compound under different configuration.

“Catalyst system” refers to a system of at least two layers including at least one substrate, a washcoat, and/or an overcoat.

“Zero platinum group (ZPGM) catalyst” refers to a catalyst completely or substantially free of platinum group metals.

“Three-Way Catalyst” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

“Milling” refers to the operation of breaking a solid material into a desired grain or particle size.

“Co-precipitation” refers to the carrying down by a precipitate of substances normally soluble under the conditions employed.

“Impregnation” refers to the process of imbuing or saturating a solid layer with a liquid compound or the diffusion of some element through a medium or substance.

“Treating, treated, or treatment” refers to drying, firing, heating, evaporating, calcining, or mixtures thereof.

“Calcination” refers to a thermal treatment process applied to solid materials, in presence of air, to bring about a thermal decomposition, phase transition, or removal of a volatile fraction at temperatures below the melting point of the solid materials.

“Oxygen storage material (OSM)” refers to a material able to take up oxygen from oxygen rich streams and able to release oxygen to oxygen deficient streams.

“Oxygen storage capacity (OSC)” refers to the ability of materials used as OSM in catalysts to store oxygen at lean and to release it at rich condition.

“Adsorption” refers to the adhesion of atoms, ions, or molecules from a gas, liquid, or dissolved solid to a surface.

“Desorption” refers to the process whereby atoms, ions, or molecules from a gas, liquid, or dissolved solid are released from or through a surface.

“Conversion” refers to the chemical alteration of at least one material into one or more other materials.

### DESCRIPTION OF THE DRAWINGS

The present disclosure may generally provide a synergized PGM (SPGM) catalyst system having enhanced catalytic performance and thermal stability, incorporating more active components into phase materials possessing three-way catalyst (TWC) properties, such as improved oxygen mobility, to enhance the catalytic activity of disclosed SPGM catalyst system.

According to embodiments in the present disclosure, SPGM catalyst systems may be configured with a washcoat (WC) layer including Cu—Mn stoichiometric spinel with Niobium-Zirconia support oxide, an overcoat (OC) layer including a PGM catalyst of palladium (Pd) with alumina-based support, and suitable ceramic substrate, here referred as SPGM catalyst system Type 1; or a WC layer including PGM catalyst of Pd with alumina-based support, an OC layer including Cu—Mn stoichiometric spinel with Niobium-Zirconia support oxide, and suitable ceramic substrate, here referred as SPGM catalyst system Type 2; or a WC layer with alumina-based support only, an OC layer including Cu—Mn stoichiometric spinel with Niobium-Zirconia support oxide, an impregnation (IM) layer including PGM, Pd in present disclosure, and suitable ceramic substrate, here referred as SPGM catalyst system Type 3; or a WC layer only, including Cu—Mn stoichiometric spinel with Niobium-Zirconia support oxide milled with a slurry including Pd and alumina and suitable ceramic substrate, here referred as SPGM catalyst system Type 4.

SPGM Catalyst System Configuration, Material Composition, and Preparation

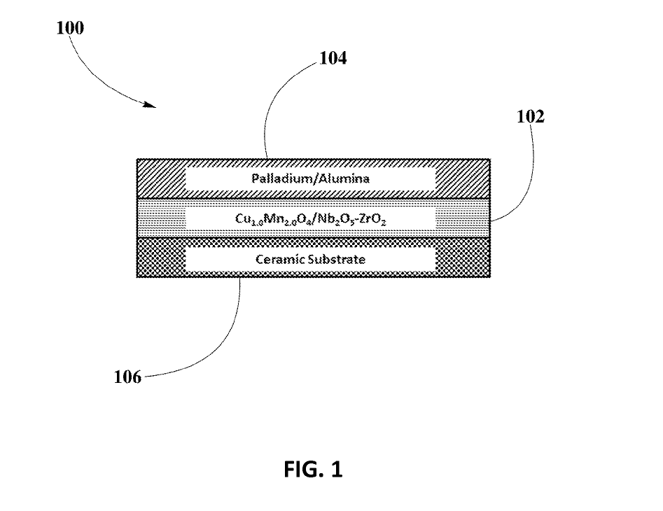

FIG. 1 shows catalyst structure 100 for SPGM catalyst system Type 1. In this system configuration, WC layer 102 may include Cu—Mn spinel structure, Cu_{1.0}Mn_{2.0}O₄, supported on Nb₂O₅—ZrO₂ by using co-precipitation method or any other preparation technique known in the art.

The preparation of WC layer 102 may begin by milling Nb₂O₅—ZrO₂ support oxide to make aqueous slurry. The Nb₂O₅—ZrO₂ support oxide may have Nb₂O₅ loadings of about 15% to about 30% by weight, preferably about 25% and ZrO₂ loadings of about 70% to about 85% by weight, preferably about 75%.

The Cu—Mn solution may be prepared by mixing an appropriate amount of Mn nitrate solution (MnNO₃) and Cu nitrate solution (CuNO₃), where the suitable copper loadings may include loadings in a range of about 10% to about 15% by weight. Suitable manganese loadings may include loadings in a range of about 15% to about 25% by weight. The next step is precipitation of Cu—Mn nitrate solution on Nb₂O₅—ZrO₂ support oxide aqueous slurry, which may have added thereto an appropriate base solution, such as in order to adjust the pH of the slurry to a suitable range. The precipitated slurry may be aged for a period of time of about 12 to 24 hours under continued stirring at room temperature.

Subsequently, the precipitated slurry may be coated on ceramic substrate 106, using a cordierite material with honeycomb structure, where ceramic substrate 106 may have a plurality of channels with suitable porosity. The aqueous slurry of Cu—Mn/Nb₂O₅—ZrO2 may be deposited on ceramic substrate 106 to form WC layer 102, employing vacuum dosing and coating systems. In the present disclosure, a plurality of capacities of WC loadings may be coated on ceramic substrate 106. The plurality of WC loading may vary from about 60 g/L to about 200 g/L, in this disclosure particularly about 120 g/L. Subsequently, after deposition on ceramic substrate 106 of suitable loadings of Cu—Mn/Nb₂O₅—ZrO₂ slurry, WC layer 102 may be dried and subsequently calcined at suitable temperature within a range of about 550° C. to about 650° C., preferably at about 600° C. for about 5 hours. Treatment of WC layer 102 may be enabled employing suitable drying and heating processes. A commercially-available air knife drying systems may be employed for drying WC layer 102. Heat treatments (calcination) may be performed using commercially-available firing (furnace) systems.

WC layer 102 deposited on ceramic substrate 106 may have a chemical composition with a total loading of about 120 g/L, including a Cu—Mn spinel structure with copper loading of about 10 g/L to about 15 g/L and manganese loading of about 20 g/L to about 25 g/L. The Nb₂O₅—ZrO₂ support oxide may have loadings of about 80 g/L to about 90 g/L.

OC layer 104 may include a combination of Pd on alumina-based support. The preparation of OC layer 104 may begin by milling the alumina-based support oxide separately to make an aqueous slurry. Subsequently, a solution of Pd nitrate may then be mixed with the aqueous slurry of alumina with a loading within a range from about 0.5 g/ft³ to about 10 g/ft³. In the present embodiment, Pd loading is about 6 g/ft³ and total loading of WC material is 120 g/L. After mixing of Pd and alumina slurry, Pd may be locked down with an appropriate amount of one or more base solutions, such as sodium hydroxide (NaOH) solution, sodium carbonate (Na₂CO₃) solution, ammonium hydroxide (NH₄OH) solution, and tetraethyl ammonium hydroxide (TEAH) solution, amongst others. No pH adjustment may be required. In the present embodiment, Pd may be locked down using a base solution of tetraethyl ammonium hydroxide (TEAH). Then the resulting slurry may be aged from about 12 hours to about 24 hours for subsequent coating as an overcoat on WC layer 102, dry and fired at about 550° C. for about 4 hours.

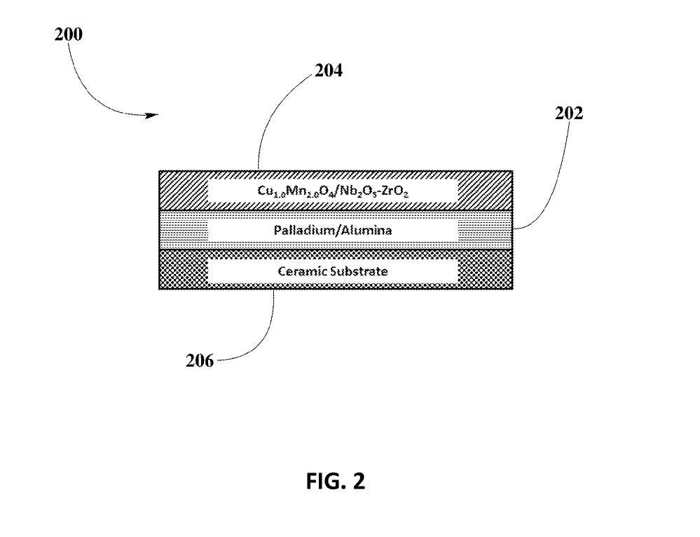

FIG. 2 illustrates catalyst structure 200 for SPGM catalyst system Type 2. In this system configuration, WC layer 202 may include a combination of Pd on alumina-based support. The preparation of WC layer 202 may begin by milling the alumina-based support oxide separately to make an aqueous slurry. Subsequently, a solution of Pd nitrate may then be mixed with the aqueous slurry of alumina with a loading within a range from about 0.5 g/ft³ to about 10 g/ft³. In the present embodiment, Pd loading is about 6 g/ft³ and total loading of WC material is 120 g/L. After mixing of Pd and alumina slurry, Pd may be locked down with an appropriate amount of one or more base solutions, such as sodium hydroxide (NaOH) solution, sodium carbonate (Na₂CO₃) solution, ammonium hydroxide (NH₄OH) solution, and tetraethyl ammonium hydroxide (TEAH) solution, amongst others. No pH adjustment is required. In the present embodiment, Pd may be locked down using a base solution of tetraethyl ammonium hydroxide (TEAH). Then the resulting slurry may be aged from about 12 hours to about 24 hours for subsequent coating as WC layer 202 on ceramic substrate 206, using a cordierite material with honeycomb structure, where ceramic substrate 106 may have a plurality of channels with suitable porosity, dry and fired at about 550° C. for about 4 hours. WC layer 202 may be deposited on ceramic substrate 106 employing vacuum dosing and coating systems.

OC layer 204 may include Cu—Mn stoichiometric spinel structure, Cu_{1.0}Mn_{2.0}O₄, supported on Nb₂O₅—ZrO₂ by using co-precipitation method or any other preparation technique known in the art.

The preparation of OC layer 204 may begin by milling Nb₂O₅—ZrO₂ support oxide to make aqueous slurry. The Nb₂O₅—ZrO₂ support oxide may have Nb₂O₅ loadings of about 15% to about 30% by weight, preferably about 25% and ZrO₂ loadings of about 70% to about 85% by weight, preferably about 75%.

The Cu—Mn solution may be prepared by mixing an appropriate amount of Mn nitrate solution (MnNO₃) and Cu nitrate solution (CuNO₃), where the suitable copper loadings may include loadings in a range of about 10% to about 15% by weight. Suitable manganese loadings may include loadings in a range of about 15% to about 25% by weight. The next step is precipitation of Cu—Mn nitrate solution on Nb₂O₅—ZrO₂ support oxide aqueous slurry, which may have added thereto an appropriate base solution, such as in order to adjust the pH of the slurry to a suitable range. The precipitated slurry may be aged for a period of time of about 12 to 24 hours under continued stirring at room temperature.

Subsequently, the precipitated slurry may be coated on WC layer 202. The aqueous slurry of Cu—Mn/Nb₂O₅—ZrO₂ may be deposited on WC layer 202, employing vacuum dosing and coating systems. In the present disclosure, a plurality of capacities of OC loadings may be coated on WC layer 202. The plurality of OC loading may vary from about 60 g/L to about 200 g/L, in this disclosure particularly about 120 g/L. Subsequently, after deposition on WC layer 202 of suitable loadings of Cu—Mn/Nb₂O₅—ZrO₂ slurry, OC layer 204 may be dried and subsequently calcined at suitable temperature within a range of about 550° C. to about 650° C., preferably at about 600° C. for about 5 hours. Treatment of OC layer 204 may be enabled employing suitable drying and heating processes. A commercially-available air knife drying systems may be employed for drying OC layer 204. Heat treatments (calcination) may be performed using commercially-available firing (furnace) systems.

OC layer 204 deposited on WC layer 202 may have a chemical composition with a total loading of about 120 g/L, including a Cu—Mn spinel structure with copper loading of about 10 g/L to about 15 g/L and manganese loading of about 20 g/L to about 25 g/L.

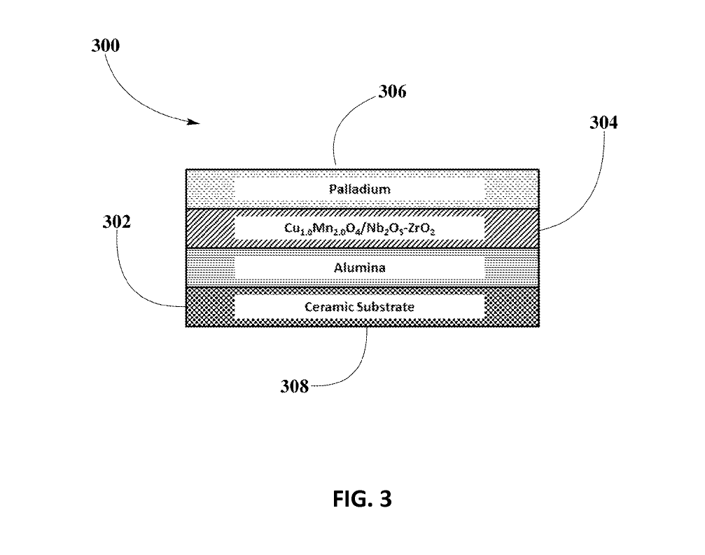

FIG. 3 depicts catalyst structure 300 for SPGM catalyst system Type 3. In the present embodiment, WC layer 302 may only include alumina-based support. The preparation of WC layer 302 may begin by milling the alumina-based support oxide to make an aqueous slurry. Then, the resulting slurry may be coated as WC layer 302 on ceramic substrate 308, using a cordierite material with honeycomb structure, where ceramic substrate 308 may have a plurality of channels with suitable porosity. The WC loading is about 120 g/L and subsequently dry and fired at about 550° C. for about 4 hours. WC layer 302 may be deposited on ceramic substrate 308 employing vacuum dosing and coating systems.

OC layer 304 may include Cu—Mn stoichiometric spinel structure, Cu_{1.0}Mn_{2.0}O₄, supported on Nb₂O₅—ZrO₂ by using co-precipitation method or any other preparation technique known in the art.

The preparation of OC layer 304 may begin by milling Nb₂O₅—ZrO₂ support oxide to make aqueous slurry. The Nb₂O₅—ZrO₂ support oxide may have Nb₂O₅ loadings of about 15% to about 30% by weight, preferably about 25% and ZrO₂ loadings of about 70% to about 85% by weight, preferably about 75%.

The Cu—Mn solution may be prepared by mixing an appropriate amount of Mn nitrate solution (MnNO₃) and Cu nitrate solution (CuNO₃), where the suitable copper loadings may include loadings in a range of about 10% to about 15% by weight. Suitable manganese loadings may include loadings in a range of about 15% to about 25% by weight. The next step is precipitation of Cu—Mn nitrate solution on Nb₂O₅—ZrO₂ support oxide aqueous slurry, which may have added thereto an appropriate base solution, such as in order to adjust the pH of the slurry to a suitable range. The precipitated slurry may be aged for a period of time of about 12 to 24 hours under continued stirring at room temperature. After aging, Cu—Mn/Nb₂O₅—ZrO₂ slurry may be coated as OC layer 304. In the present disclosure, a plurality of capacities of OC loadings may be coated on WC layer 302. The plurality of OC loading may vary from about 60 g/L to about 200 g/L, in this disclosure particularly about 120 g/L, to include the Cu—Mn spinel structure with copper loading of about 10 g/L to about 15 g/L and manganese loading of about 20 g/L to about 25 g/L. The Nb₂O₅—ZrO₂ support oxide may have loadings of about 80 g/L to about 90 g/L.

OC layer 304 may be dried and subsequently calcined at suitable temperature within a range of about 550° C. to about 650° C., preferably at about 600° C. for about 5 hours. Treatment of OC layer 304 may be enabled employing suitable drying and heating processes. A commercially-available air knife drying systems may be employed for drying OC layer 304. Heat treatments (calcination) may be performed using commercially-available firing (furnace) systems.

Subsequently, IMP layer 306 may be prepared with a solution of Pd nitrate which may be impregnated on top of OC layer 304 for drying and firing at about 550° C. for about 4 hours to complete catalyst structure 300. The final loading of Pd in the catalyst system may be within a range from about 0.5 g/ft³ to about 10 g/ft³. In the present embodiment, Pd loading is about 6 g/ft³.

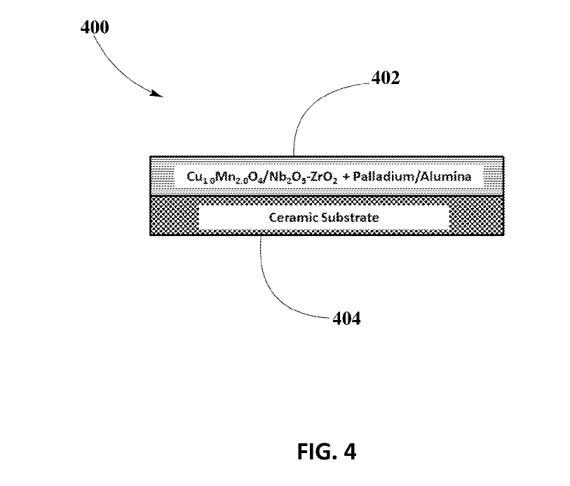

FIG. 4 illustrates catalyst structure 400 for SPGM catalyst system Type 4. In this system configuration, WC layer 402 may include Cu—Mn stoichiometric spinel structure, Cu_{1.0}Mn_{2.0}O₄, supported on Nb₂O₅—ZrO₂ and PGM supported on alumina by using co-precipitation method or any other preparation technique known in the art.

The preparation of WC layer 402 may begin by milling Nb₂O₅—ZrO₂ support oxide to make aqueous slurry. The Nb₂O₅—ZrO₂ support oxide may have Nb₂O₅ loadings of about 15% to about 30% by weight, preferably about 25% and ZrO₂ loadings of about 70% to about 85% by weight, preferably about 75%.

The Cu—Mn solution may be prepared by mixing an appropriate amount of Mn nitrate solution (MnNO₃) and Cu nitrate solution (CuNO₃), where the suitable copper loadings may include loadings in a range of about 10% to about 15% by weight. Suitable manganese loadings may include loadings in a range of about 15% to about 25% by weight. The next step is precipitation of Cu—Mn nitrate solution on Nb₂O₅—ZrO₂ support oxide aqueous slurry, which may have added thereto an appropriate base solution, such as in order to adjust the pH of the slurry to a suitable range. The precipitated slurry may be aged for a period of time of about 12 to 24 hours under continued stirring at room temperature.

After precipitation step, the Cu—Mn/Nb₂O₅—ZrO₂ slurry may undergo filtering and washing, then the resulting material may be dried overnight at about 120° C. and subsequently calcined at suitable temperature within a range of about 550° C. to about 650° C., preferably at about 600° C. for about 5 hours. The prepared Cu—Mn/Nb₂O₅—ZrO₂ powder may be ground to fine grain powder to be added to Pd and alumina included in WC layer 402.

Fine grain powder of Cu—Mn/Nb₂O₅—ZrO₂ may be subsequently added to a combination of Pd and alumina-based support oxide slurry. The preparation of the Pd and alumina slurry may begin by milling the alumina-based support oxide separately to make an aqueous slurry. Subsequently, a solution of Pd nitrate may then be mixed with the aqueous slurry of alumina. In the present embodiment, Pd loading is about 6 g/ft³ and total loading of WC material is 120 g/L. After mixing of Pd and alumina slurry, Pd may be locked down with an appropriate amount of one or more base solutions, such as sodium hydroxide (NaOH) solution, sodium carbonate (Na₂CO₃) solution, ammonium hydroxide (NH₄OH) solution, tetraethyl ammonium hydroxide (TEAH) solution, amongst others. No pH adjustment is required. In the present embodiment, Pd may be locked down using a base solution of tetraethyl ammonium hydroxide (TEAH). Then the resulting slurry, including fine grain powder of Cu—Mn/Nb₂O₅—ZrO₂, may be aged from about 12 hours to about 24 hours for subsequent coating as WC layer 402. The aged slurry may be coated on ceramic substrate 404, using a cordierite material with honeycomb structure, where ceramic substrate 404 may have a plurality of channels with suitable porosity. The aqueous slurry of Cu—Mn/Nb₂O₅—ZrO₂ and Pd/Alumina may be deposited on ceramic substrate 404 to form WC layer 402, employing vacuum dosing and coating systems. In the present disclosure, a plurality of capacities of WC loadings may be coated on ceramic substrate 404. The plurality of WC loading may vary from about 60 g/L to about 200 g/L, in this disclosure particularly about 120 g/L.

Treatment of WC layer 402 may be enabled employing suitable drying and heating processes. A commercially-available air knife drying systems may be employed for drying WC layer 402. Heat treatments (calcination) may be performed using commercially-available firing (furnace) systems.

WC layer 402 deposited on ceramic substrate 404 may have a chemical composition with a total loading of about 120 g/L, including a Cu—Mn spinel structure with copper loading of about 10 g/L to about 15 g/L, manganese loading of about 20 g/L to about 25 g/L, and Pd loading of about 6 g/ft³.

According to principles in the present disclosure, the SPGM catalyst systems Type 1, Type 2, Type 3 and Type 4 are free of rare earth metal groups. No Lanthanides and especially CeO₂ were used in preparation of disclosed SPGM catalyst systems. The SPGM catalyst systems Type 1, Type 2, Type 3 and Type 4 may be subjected to testing under OSC isothermal oscillating condition to determine the O₂ and CO delay times and OSC property at a selected temperature. A set of different O₂ and CO delay times may be obtained when a range of temperatures may be chosen to further characterize the OSC property of the SPGM catalyst systems Type 1, Type 2, Type 3, and Type 4.

Results from OSC isothermal oscillating tests may be compared to show the optimal composition and configuration of disclosed SPGM catalyst systems for optimal OSC property and therefore optimal performance under TWC condition. In order to check the thermal stability of the SPGM catalyst systems in present disclosure, samples may be hydrothermally aged employing about 10% steam/air in a range of temperatures from about 800° C. to about 1,000° C. for about 4 hours and results compared with a plurality of fresh samples, including samples of a commercial PGM catalyst including oxygen storage material (OSM).

OSC Isothermal Oscillating Test Procedure

Testing of the OSC property of fresh and hydrothermally aged samples of SPGM catalyst systems Type 1, Type 2, Type 3, Type 4, and PGM catalysts may be performed under isothermal oscillating condition to determine O₂ and CO delay times, the time required to reach to 50% of the O₂ and CO concentration in feed signal, used as parameters for performance comparison of the SPGM catalyst systems and PGM catalysts.

The OSC isothermal test may be carried out at temperature of about 575° C. with a feed of either O₂ with a concentration of about 4,000 ppm diluted in inert nitrogen (N₂), or CO with a concentration of about 8,000 ppm of CO diluted in inert N₂. The OSC isothermal oscillating test may be performed in a quartz reactor using a space velocity (SV) of 60,000 hr⁻¹, ramping from room temperature to isothermal temperature of about 575° C. under dry N₂. At the temperature of about 575° C., OSC test may be initiated by flowing O₂ through the catalyst sample in the reactor, and after 2 minutes, the feed flow may be switched to CO to flow through the catalyst sample in the reactor for another 2 minutes, enabling the isothermal oscillating condition between CO and O₂ flows during a total time of about 1,000 seconds. Additionally, O₂ and CO may be allowed to flow in the empty test reactor not including the catalyst sample. Subsequently, testing may be performed allowing O₂ and CO to flow in the test tube reactor including a fresh or hydrothermally aged catalyst sample and observe/measure the OSC property of the catalyst sample. As the catalyst sample may have OSC property, the catalyst sample may store O₂ when O₂ flows. Subsequently, when CO may flow, there is no O₂ flowing, and the O₂ stored in the catalyst sample may react with the CO to form CO₂. The time during which the catalyst sample may store O₂ and the time during which CO may be oxidized to form CO₂ may be measured.

OSC Property of Fresh Samples of SPGM Catalyst Systems

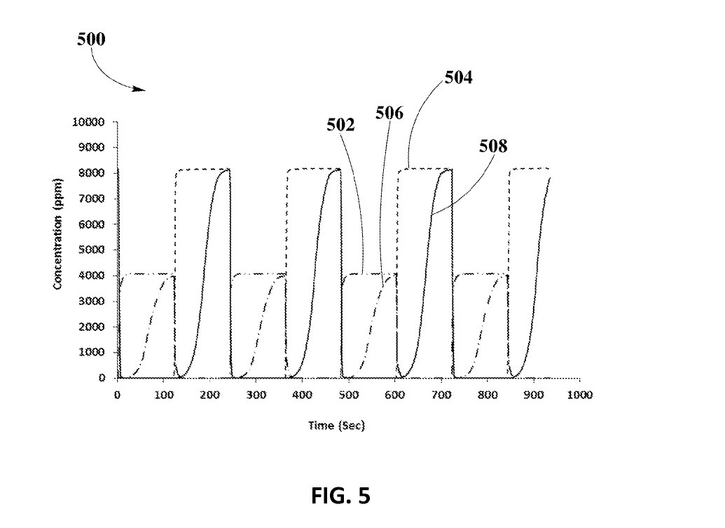

FIG. 5 shows OSC isothermal oscillating test 500 for a fresh sample of SPGM catalyst system Type 1 at temperature of about 575° C., according to an embodiment. OSC isothermal oscillating test 500 may be performed in a reactor using SV of 60,000 hr⁻¹, ramping from room temperature to isothermal temperature of about 575° C. under dry N₂. Repeated switching from flowing O₂ and flowing CO may be enabled every 2 minutes for a total time of about 1,000 seconds.

In FIG. 5, curve 502 (double-dot dashed graph) shows the result of flowing 4,000 ppm O₂ through an empty test reactor which may be used for OSC isothermal oscillating test 500; curve 504 (dashed graph) depicts the result of flowing 8,000 ppm CO through the empty test reactor; curve 506 (single-dot dashed graph) shows the result of flowing 4,000 ppm O₂ through the test reactor including the fresh sample of SPGM catalyst system Type 1; and curve 508 (solid line graph) depicts the result of flowing 8,000 ppm CO through the test reactor including the fresh sample of SPGM catalyst system Type 1.

It may be observed in FIG. 5 that the O₂ signal in presence of the fresh sample of SPGM catalyst system Type 1, as shown in curve 506, does not reach the O₂ signal of empty reactor shown in curve 502. This result indicates the storage of a large amount of O₂ in the fresh sample of SPGM catalyst systems Type 1. The measured O₂ delay time, which is the time required to reach an O₂ concentration of 2,000 ppm (50% of feed signal), in presence of the fresh sample of SPGM catalyst system Type 1 is about 64.62 seconds. The O₂ delay time measured from OSC isothermal oscillating test 500 indicates that the fresh sample of SPGM catalyst systems Type 1 has a significant OSC property.

Similar result may be observed for CO. As may be seen, the CO signal in presence of the fresh sample of SPGM catalyst system Type 1, shown in curve 508, does not reach the CO signal of empty reactor shown in curve 504. This result indicates the consumption of a significant amount of CO by the fresh sample of SPGM catalyst system Type 1 and desorption of stored O₂ for the conversion of CO to CO₂. The measured CO delay time, which is the time required to reach to a CO concentration of 4000 ppm, in the presence of the fresh sample of SPGM catalyst system Type 1 is about 61.53 seconds. The CO delay time measured from OSC isothermal oscillating test 500 shows that the fresh sample of SPGM catalyst system Type 1 has significant OSC property.

The measured O₂ delay time and CO delay times may be an indication that the fresh sample of SPGM catalyst system Type 1 may exhibit enhanced OSC as noted by the highly activated total and reversible oxygen adsorption and CO conversion that occurs under isothermal oscillating condition.

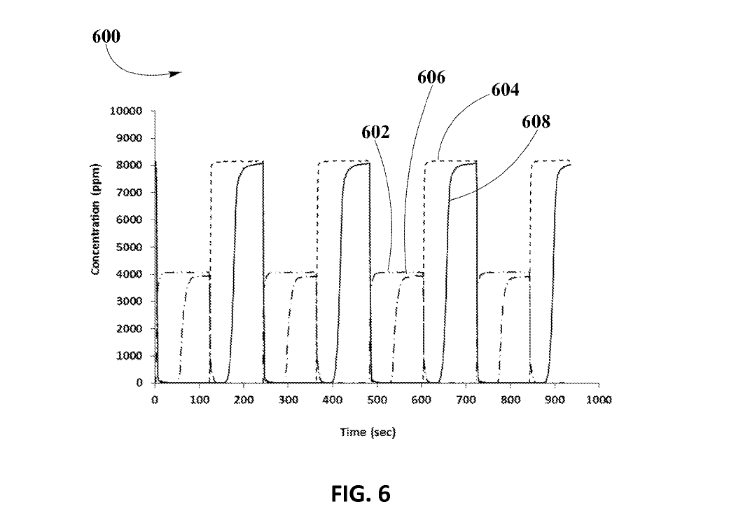

FIG. 6 shows OSC isothermal oscillating test 600 for a fresh sample of SPGM catalyst system Type 2 at temperature of about 575° C., according to an embodiment. OSC isothermal oscillating test 600 may be performed in a reactor using SV of 60,000 hr-1, ramping from room temperature to isothermal temperature of about 575° C. under dry N₂. Repeated switching from flowing O₂ and flowing CO may be enabled every 2 minutes for a total time of about 1,000 seconds.

In FIG. 6, curve 602 (double-dot dashed graph) shows the result of flowing 4,000 ppm O₂ through an empty test reactor which may be used for OSC isothermal oscillating test 600; curve 604 (dashed graph) depicts the result of flowing 8,000 ppm CO through the empty test reactor; curve 606 (single-dot dashed graph) shows the result of flowing 4,000 ppm O₂ through the test reactor including the fresh sample of SPGM catalyst system Type 2; and curve 608 (solid line graph) depicts the result of flowing 8,000 ppm CO through the test reactor including the fresh sample of SPGM catalyst system Type 2.

It may be observed in FIG. 6 that the O₂ signal in presence of the fresh sample of SPGM catalyst system Type 2, as shown in curve 606, does not reach the O₂ signal of empty reactor shown in curve 602. This result indicates the storage of a large amount of O₂ in disclosed sample of SPGM catalyst system Type 2. The measured O₂ delay time, which is the time required to reach to an O₂ concentration of 2,000 ppm (50% of feed signal), in presence of the fresh sample of SPGM catalyst system Type 2, is about 55.11 seconds. The O₂ delay time measured from OSC isothermal oscillating test 600 indicates that the fresh sample of SPGM catalyst system Type 2 has significant OSC property lower than the OSC property exhibited by the fresh sample of SPGM catalyst system Type 1.

Similar result may be observed for CO. As may be seen, the CO signal in presence of fresh sample of SPGM catalyst system Type 2, shown in curve 608, does not reach the CO signal of empty reactor shown in curve 604. This result indicates the consumption of a significant amount of CO by the fresh sample of SPGM catalyst system Type 2 and desorption of stored O₂ for the conversion of CO to CO₂. The measured CO delay time, which is the time required to reach to a CO concentration of 4000 ppm in the presence of fresh sample of SPGM catalyst system Type 2 is about 51.37 seconds. The CO delay time measured from OSC isothermal oscillating test 600 shows that the fresh sample of SPGM catalyst system Type 2 has a significant OSC property lower than the OSC property exhibited by the fresh sample of SPGM catalyst system Type 1.

The measured O₂ delay time and CO delay times may be an indication that the fresh sample of SPGM catalyst system Type 2 may exhibit increased OSC as noted by the highly activated total and reversible oxygen adsorption and CO conversion that occurs under isothermal oscillating condition. However, comparison of SPGM catalyst system Type 1 and SPGM catalyst system Type 2 shows that SPGM catalyst system Type 1 shows higher OSC property than SPGM catalyst system Type 2. Disclosed SPGM catalyst systems are free of lanthanides and specially free of Ce compounds. The high OSC observed is the result of the OSC property of the Cu—Mn spinel.

Dependency of OSC Property of SPGM Catalyst System to Temperature

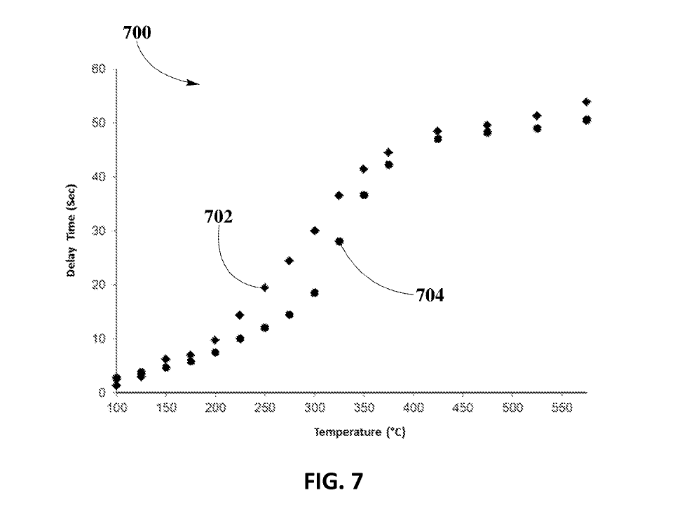

FIG. 7 depicts OSC property 700 of a fresh sample of SPGM catalyst system Type 3 with variation of temperature, according to an embodiment.

A plurality of isothermal oscillating tests may be performed for fresh samples of SPGM catalyst system Type 3 using a series of selected temperatures within the range of about 100° C. to about 600° C. OSC isothermal oscillating tests may be performed in a reactor using SV of 60,000 hr⁻¹, ramping from room temperature to isothermal temperature within the range of about 100° C. to about 600° C. under dry N₂. Repeated switching from flowing O₂ and flowing CO may be enabled every 2 minutes for a total time of about 1,000 seconds for each temperature.

As may be observed in FIG. 7, each of data points 702 (diamond symbols) represents an isothermal oscillating test performed at a selected temperature from which the corresponding O₂ delay time may be measured. Additionally, each of data points 704 (circle symbols) represents an isothermal oscillating test performed at a selected temperature from which the corresponding CO delay time may be measured.

As may be observed in FIG. 7, the OSC property of the fresh samples of SPGM catalyst system Type 3 increases when the temperature increases. This behavior may be an indication of the enhanced activity of the SPGM catalyst system Type 3 which may be observed for temperatures within this range, for the different reactions that may occur and for the different catalyst applications in which the fresh sample of SPGM catalyst system Type 3 may provide enhanced OSC. The SPGM catalyst system Type 3 may provide enhanced OSC, while maintaining or even improving upon increasing temperature and facile nature of the redox function of the used chemical components. Moreover, as may be seen in FIG. 7, even at low temperature, below 300° C., there is extensive OSC property as depicted by O₂ delay time. The same temperature dependency was also observed for SPGM catalyst systems Type 1, Type 2 and Type 4.

As may be seen in OSC property 700, when the fresh sample of SPGM catalyst system Type 3 is compared with fresh samples of SPGM catalyst system Type 1 and Type 2, the O₂ delay time for isothermal oscillating condition at about 575° C. for SPGM catalyst system Type 3 is about 53.86 seconds while for the fresh samples of SPGM catalyst systems Type 1 and Type 2, at the same temperature, the O₂ delay time is about 64.62 seconds and 55.11 seconds respectively, indicating a higher level of activity and OSC property of SPGM catalyst systems Type 1 and Type 2.

Comparison of OSC Property of SPGM Catalyst Systems and Commercial PGM Catalyst

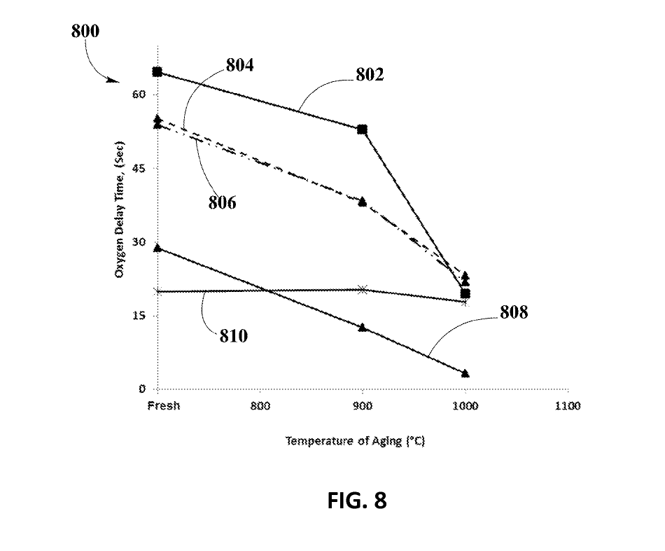

FIG. 8 shows comparison of O₂ delay time results from OSC isothermal oscillating tests 800 performed at 575° C., for fresh and hydrothermally aged samples of SPGM catalyst systems Type 1, Type 2, Type 3, Type 4, and commercial PGM catalyst with OSM, according to an embodiment. Samples of SPGM catalyst systems Type 1, Type 2, Type 3, Type 4, and commercial PGM catalyst with OSM may be hydrothermally aged employing about 10% steam/air at temperatures of about 900° C. and about 1,000° C. for about 4 hours.

PGM catalyst with OSM is a commercial PGM catalyst. The samples of PGM catalyst may be palladium (Pd) catalysts including 20 g/ft³ Pd and OSM, using loading of about 60% by weight. The OSM may include mostly CeO₂, with loading of about 30% to about 40% by weight.

As can be seen in FIG. 8, curve 802 (solid line with square marker) shows oxygen delay times for fresh and aged samples of SPGM catalyst system Type 1; curve 804 (dashed line) depicts oxygen delay times for fresh and aged samples of SPGM catalyst system Type 2; curve 806 (double-dot dashed line) shows oxygen delay times for fresh and aged samples of SPGM catalyst system Type 3; curve 808 (solid line with triangular marker) depicts oxygen delay times for fresh and aged samples of SPGM catalyst system Type 4; and curve 810 (solid line with asterisk marker) shows oxygen delay times for fresh and aged samples of commercial PGM catalyst with OSM.

In FIG. 8, resulting oxygen delay time for fresh sample of SPGM catalyst system Type 1 is about 64.62 seconds, and oxygen delay times for hydrothermally aged samples of SPGM catalyst system Type 1 at about 900° C. and about 1,000° C. are about 52.96 seconds and about 19.53 seconds respectively. Results show lower oxygen delay times for fresh samples of SPGM catalyst systems Type 2, Type 3, and Type 4, which are respectively about 14.72%, 16.65%, and 55.42% lower than oxygen delay time for fresh sample of SPGM catalyst system Type 1. Fresh sample of PGM catalyst with OSM has an oxygen delay time which is about 69.00% lower than fresh sample of SPGM catalyst system Type 1. The comparison of fresh samples of the disclosed SPGM catalyst systems with PGM catalyst with OSM indicates that fresh samples of disclosed SPGM catalyst systems presents better performance than commercial PGM catalyst with OSM. There is a significant and increasing OSC property when PGM catalysts may be synergized adding ZPGM material, disclosed Cu—Mn spinel, to composition of the PGM catalyst.

For hydrothermally aged samples at about 900° C., SPGM catalyst systems Type 2, Type 3, and Type 4 shows lower oxygen delay times than SPGM catalyst system Type 1. The resulting oxygen delay times are respectively about 28.10%, 27.47%, and 76.15% lower than aged sample of SPGM catalyst system Type 1. The sample of PGM catalyst with OSM hydrothermally aged at about 900° C. has an oxygen delay time which is about 61.52% lower than fresh sample of SPGM catalyst system Type 1. As may be seen, synergistic effect of adding ZPGM material on PGM catalyst improves OSC property of disclosed SPGM catalyst systems Type 1, Type 2, and Type 3. Only SPGM catalyst system Type 4 shows less performance than PGM catalyst with OSM.

For hydrothermally aged samples at about 1,000° C., SPGM catalyst systems Type 1, Type 2, and Type 3 present slightly better oxygen delay times than commercial PGM catalyst system. The oxygen delay time for commercial PGM catalyst with OSM is measured at 17.79 seconds, while the oxygen delay time for SPGM catalyst systems Type 1, Type 2, and Type 3 is respectively 19.53 seconds, 23.22 seconds, and 21.78 seconds. The aged sample of SPGM catalyst system Type 4 shows oxygen delay time of about 3.30 seconds, which is the lowest oxygen delay time obtained during OSC isothermal oscillating test of disclosed SPGM catalyst systems.

As may be seen, synergistic effect of adding ZPGM material on PGM catalyst improves OSC property of disclosed SPGM catalyst systems Type 1, Type 2, and Type 3, even after hydrothermal aging at about 900° C. and about 1,000° C. for 4 hours. Having higher OSC property of disclosed SPGM catalyst systems as compared with commercial PGM catalysts confirms improved thermal stability of synergized PGM.

Based on results of OSC isothermal oscillating tests performed on fresh and hydrothermally aged samples, disclosed SPGM catalyst systems Type 1, Type 2, and Type 3 may be selected for a plurality of TWC applications, with fresh sample of SPGM catalyst system Type 1 showing the best performance and optimal OSC property under isothermal oscillating condition. It may also be observed from FIG. 8 that fresh samples of SPGM catalyst systems, hydrothermally treated at about 900° C. and about 1000° C. may also be selected as substitutes for commercial PGM catalysts with OSM, given their improved thermal stability and OSC property, and therefore performance as fresh and hydrothermally aged samples in comparison with commercial PGM catalysts with OSM. There is enhanced significant OSC property resulting from the synergistic effect of adding ZPGM material to PGM catalyst.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalyst system, comprising:
at least one substrate;
at least one washcoat comprising at least one oxygen storage material further comprising Cu—Mn spinel having a niobium-zirconia support oxide; and
at least one overcoat comprising at least one platinum group metal catalyst and Al₂O₃;
wherein the O₂ storage capacity of the at least one oxygen storage material increases with temperature.

2. The catalyst system of claim 1, wherein the at least one oxygen storage material is hydrothermally aged at about 900° C.

3. The catalyst system of claim 1, wherein the hydrothermal aging is for about 4 hours.

4. The catalyst system of claim 1, wherein the at least one oxygen storage material is hydrothermally aged at about 1,000° C.

5. The catalyst system of claim 1, wherein the hydrothermal aging is for about 4 hours.

6. The catalyst system of claim 1, wherein the Cu—Mn spinel comprises CuMn₂O₄.

7. The catalyst system of claim 1, wherein the Cu—Mn spinel is stoichiometric.

8. The catalyst system of claim 1, wherein the niobium-zirconia support oxide comprises Nb₂O₅—ZrO₂.

9. The catalyst system of claim 1, further comprising at least one impregnation layer.

10. The catalyst of claim 1, wherein the at least one substrate comprises a ceramic.

11. A catalyst system, comprising:
at least one substrate;
at least one washcoat comprising at least one platinum group metal catalyst and Al₂O₃; and
at least one overcoat comprising at least one oxygen storage material further comprising Cu—Mn spinel having a niobium-zirconia support oxide;
wherein the O₂ storage capacity of the at least one oxygen storage material increases with temperature.

12. The catalyst system of claim 12, wherein the at least one oxygen storage material is hydrothermally aged at about 900° C.

13. The catalyst system of claim 12, wherein the hydrothermal aging is for about 4 hours.

14. The catalyst system of claim 12, wherein the at least one oxygen storage material is hydrothermally aged at about 1,000° C.

15. The catalyst system of claim 12, wherein the hydrothermal aging is for about 4 hours.

16. The catalyst system of claim 12, wherein the Cu—Mn spinel comprises CuMn₂O₄.

17. The catalyst system of claim 12, wherein the Cu—Mn spinel is stoichiometric.

18. The catalyst system of claim 12, wherein the niobium-zirconia support oxide comprises Nb₂O₅—ZrO₂.

19. The catalyst system of claim 12, further comprising at least one impregnation layer.

20. A catalyst system, comprising:
at least one substrate comprising ceramics;
at least one washcoat comprising Al₂O₃;
at least one overcoat comprising at least one oxygen storage material further comprising Cu—Mn spinel having a niobium-zirconia support oxide; and
at least one impregnation layer comprising at least one platinum group metal catalyst;
wherein the at least one platinum group metal catalyst comprises palladium; and
wherein the O₂ storage capacity of the at least one oxygen storage material increases with temperature.
